(19) United States
(12) Patent Application Publication
(10) Pub. No.: US 2007/0129822 A1
(43) Pub. Date: Jun. 7, 2007

(54) Methods and systems for operating a termination machine

(75) Inventor: Keith Lynn Nicholas, Harrisburg, PA (US)

Correspondence Address: Lisa B. Vaccarelli;Tyco Electronics Corporation, Suite 140, 4550 New Linden Hill Road, Wilmington, DE, 19808-2952, US

(73) Assignee: Tyco Electronics Corporation

(21) Appl. No.: 11/605,105

(22) Filed: Nov. 28, 2006

Related U.S. Application Data
(60) Provisional application No. 60/742,249, filed on Dec. 5, 2005.

(51) Int. Cl. G05B 13/02

(52) U.S. Cl. 700/32

(57) ABSTRACT

A termination system used to apply a terminal to a wire includes a movable ram configured to be driven by a termination machine and tooling coupled to the movable ram and configured to apply the terminal to the wire. A smart tag having data related to the applicator is configured to communicate with the termination machine to control an operation of the termination machine. Optionally, the smart tag may store data in a memory, and the smart tag may be configured to send data to and receive data from a microprocessor of the termination machine. The smart tag may store at least one type of data including, but not limited to, data relating to a feeding operation of the terminating machine, data relating to a terminating operation of the terminating machine, data relating to set-up parameters for the terminating machine, data relating to changes in the set-up parameters of the terminating machine, data relating to a maintenance schedule of the applicator, and data relating to identification of the applicator.

### BACKGROUND OF THE INVENTION

This invention relates generally to methods and devices for operating a termination machine, and more particularly, to methods and devices for storing terminal crimping applicator operational data and transferring the data to a termination machine to automatically adjust the machine for the specific applicator.

In a termination machine, a wire is terminated with a terminal or connector. Applicators are mounted on the termination machine to properly apply the terminal to the wire. Various applicators are used with the termination machine based on the specific wire and specific terminal. Consequently, applicator changeover is required for the application of different terminals.

Currently significant operator input is required for setup for each applicator installed onto a termination machine. Specific settings and adjustments on the termination machine are required for each individual applicator. Critical data related to each specific applicator, such as, terminator adjustment position for the proper crimp height, is either recorded in a file on the termination machine or recorded external to the termination machine.

At each applicator changeover, significant time and care by the operator is required to verify that the correct information is loaded into the termination machine for the specific applicator. For example, incorrect data loaded by the operator or other operator error may lead to tooling crashes or improperly crimped connectors. Thus, more process steps and/or more time is required at each applicator changeover.

A need remains for a device and method which reduces the setup time for an applicator changeover and reduces the possibility of operator error. A need also remains for a device and method which provides the ability to automatically or programmably make adjustments that are currently done manually.

### BRIEF DESCRIPTION OF THE INVENTION

In one aspect, a termination system is provided and used to apply a terminal to a wire. The system includes a movable ram configured to be driven by a termination machine and tooling coupled to the movable ram and configured to apply the terminal to the wire. A smart tag having data related to the applicator is configured to communicate with the termination machine to control an operation of the termination machine.

Optionally, the smart tag may store data in a memory, and the smart tag may be configured to send data to and receive data from a microprocessor of the termination machine. The smart tag may be permanently mounted to the applicator. The smart tag may store at least one type of data including, but not limited to, data relating to a feeding operation of the terminating machine, data relating to a terminating operation of the terminating machine, data relating to set-up parameters for the terminating machine, data relating to changes in the set-up parameters of the terminating machine, data relating to a maintenance schedule of the applicator, and data relating to identification of the applicator.

In another aspect, a termination system is provided for applying a terminal to a wire. The termination system includes an applicator having a movable ram, tooling coupled to the movable ram and configured to apply the terminal to the wire, and a smart tag having data relating to the applicator. The termination system also includes a termination machine having a driving mechanism coupled to the movable ram for driving the movable ram along a termination stroke and an operating system configured to operate the driving mechanism. The operating system communicates with the smart tag to control an operation of the termination machine.

In a further aspect, a method is provided of operating a termination machine including an applicator having a smart tag. The method includes storing terminal crimping applicator specific data in the smart tag of the applicator, and mounting the applicator onto the termination machine. The method also includes uploading the data to the termination machine, and operating the termination machine based on the uploaded data.

### BRIEF DESCRIPTION OF THE DRAWINGS

FIG. 1 illustrates a perspective view of a termination machine formed in accordance with an exemplary embodiment.

FIG. 2 schematically illustrates an exemplary operating system for the termination machine shown in FIG. 1.

FIG. 3 illustrates a perspective view of an exemplary side-feed applicator for the termination machine shown in FIG. 1.

FIG. 4 illustrates a perspective view of an exemplary end-feed applicator for the termination machine shown in FIG. 1.

FIG. 5 illustrates a perspective view of an exemplary feeder for the termination machine shown in FIG. 1.

FIG. 6 illustrates a control interface formed in accordance with an exemplary embodiment and used with the termination machine shown in FIG. 1.

FIG. 7 illustrates an exemplary database system for the termination machine shown in FIG. 1.

FIG. 8 illustrates an exemplary interface for populating portions of the database system illustrated in FIG. 7.

### DETAILED DESCRIPTION OF THE INVENTION

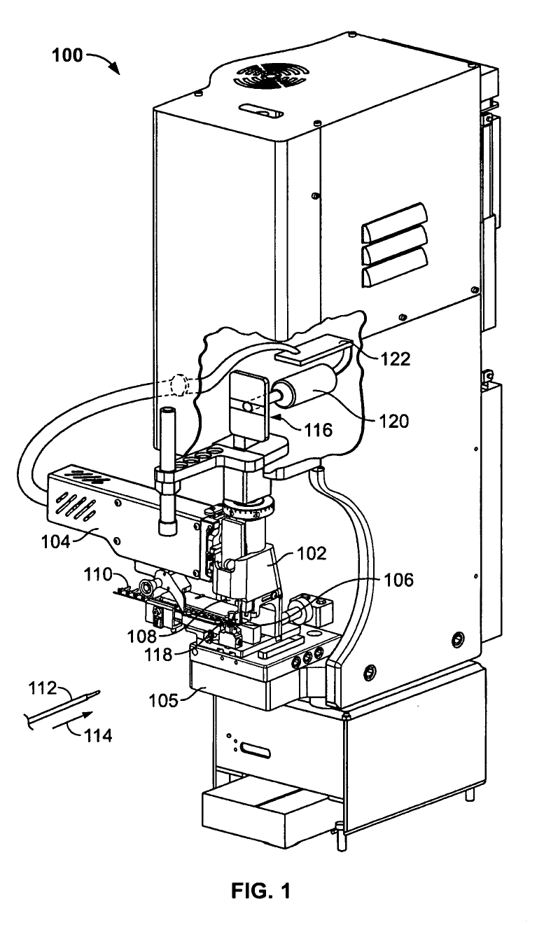

FIG. 1 illustrates a perspective view of a termination machine 100 having a termination tool 102 with tooling 108 and a feeder 104. The termination machine 100 is illustrated as a terminal crimping machine used for crimping connectors to wires, however, other types of termination machine 100 may be used, such as, an IDC machine, a welding machine, and the like that attach connectors to wires using processes other than crimping. While the terminal crimping machine is illustrated as being a terminator or press, and referred to hereinafter as terminator 100, other types of terminal crimping machines may similarly be used, such as a lead maker, a bench machine, and the like. Furthermore, while the termination tool 102 is illustrated and described hereinafter with respect to an applicator 102, other types of termination tools 102 may be used depending on the type of termination machine. Additionally, while the tooling 108 is illustrated and described hereinafter with respect to crimp tooling 108, other types of tooling may be used depending on the type of termination machine. Moreover, while the feeder 104 is illustrated and described hereinafter with respect to an electrically actuated feeder 104, other types of feeders 104, such as pneumatic feeders, cam and linkage feeders, and the like, may be used depending on the type of termination machine.

The applicator 102 is coupled to a frame 105 of the terminator 100. The applicator 102 has a terminating zone or crimping zone 106 in the case of the terminator 100. The crimp tooling 108 is coupled to the applicator 102 for crimping electrical connectors or terminals 110 to an end of a wire 112 in the crimping zone 106. The applicator 102 may be removed and replaced with a different applicator, such as when a different size/type of terminal 110 is to be terminated, when a different size/type of wire 112 is to be terminated, when the applicator 102 is worn or damaged, or when an applicator having a different configuration is desired. As such, multiple applicators 102 may be used with each terminator 100, and the different applicators 102 may have different set-up configurations.

The feeder 104 is positioned to feed terminals 110 accurately to the applicator 102 and presents the terminals 110 to the crimping zone 106. Optionally, the feeder 104 may be positioned adjacent to, or even coupled to, the applicator 102. Alternatively, the feeder 104 may be positioned remote with respect to the applicator 102, but still delivers the terminals 110 to the crimping zone 106. The feeder 104 may be used with different applicators 102 by removing the feeder 104 from the applicator 102 and mounting the feeder 104 to a different applicator 102. The terminals 110 may be guided to the crimp zone 106 by a guide member (not shown) of the feeder 104 to ensure proper positioning of the terminals 110 within the crimping zone 106. The wires 112 are delivered to the crimping zone 106 by a wire feeder, wire transfer, swivel mechanism, or the like (not shown) for the lead maker or terminator, or an operator for a bench machine. The wires 112 are delivered in a wire loading direction 114. The feeder 104 may be configured to deliver, and the applicator 102 may be configured to receive, multiple sized terminals 110 for crimping. The feeder 104 may be configured to deliver either side-feed terminals or end-feed terminals. Side-feed terminals are arranged side-by-side on a carrier strip and end-feed terminals are arranged successively, end-to-end.

The terminator 100 may receive applicators 102 designed for terminating a specific type of terminal, such as a side-feed terminal or an end-feed terminal. Some applicators 102 may be designed to accommodate more than one type of terminal. Additionally, the terminator 100 may receive different applicators 102 designed for different sized or shaped terminals 110. For example, a terminator 100 may be capable of terminating as many as 48 different types of terminals, or more. A specific type of applicator 102 may accommodate a predefined sub-set of the terminals 110, such as five different types of terminals 110, or more. Thus, the applicators 102 may be interchanged with the terminator 100 for a different run of terminals 110. Similarly, the terminator 100 may receive applicators 102 for different sized or type of wires 112. For example, a terminator 100 may be capable of terminating as many as 14 different types of wires 112, or more. A specific type of applicator 102 may accommodate a predefined sub-set of the wires 112, such as four different sized wires 112, or more. Thus, the applicators 102 may be interchanged with the terminator 100 for a different run of wires 112. Moreover, a first type of applicator 102 may receive side-feed terminals and a second type of applicator 102 may receive end-feed terminals. The side-feed and end-feed types of applicators 102 may be interchanged with the terminator 100. A side-feed type applicator 102 is illustrated in FIG. 1.

During operation, the crimp-tooling 108 is driven through a crimp stroke by a driving mechanism 116 of the terminator 100 toward a stationary anvil 118. The crimp stroke has both a downward component and an upward component. The crimping of the terminal 110 to the wire 112 occurs during the downward component of the crimp stroke. The driving mechanism 116 is driven by a terminator actuator 120. Optionally, the terminator actuator 120 may be a motor having a drive shaft that moves the driving mechanism 116. Alternatively, the terminator actuator 120 may be a linear actuator, a piezoelectric actuator, a pneumatic actuator, and the like. The operation of the terminator actuator 120 is controlled by a control module 122.

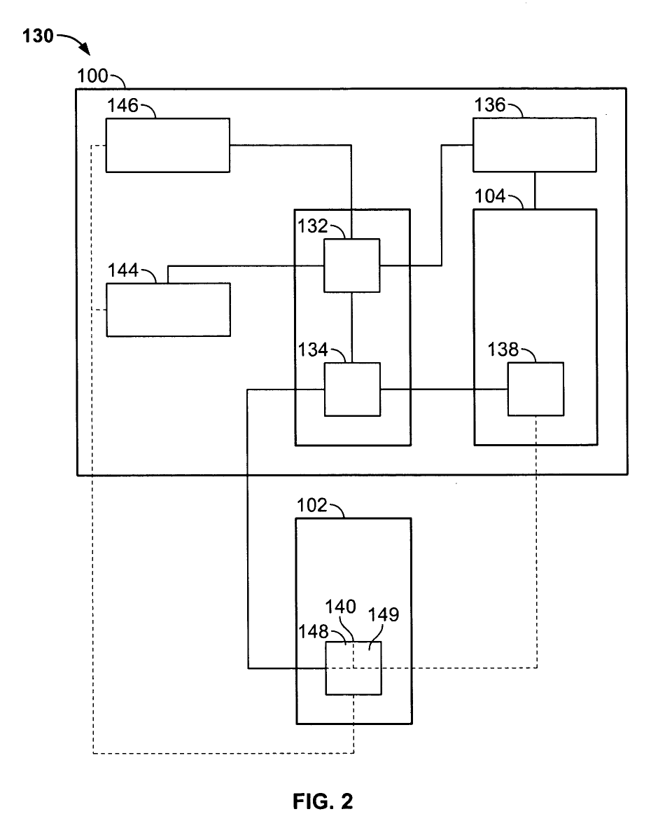

FIG. 2 schematically illustrates an exemplary operating system 130 for the terminator 100, applicator 102 and feeder 104. The operating system 130 includes a main controller 132, which may be formed in whole or in part by the control module 122 (shown in FIG. 1), and an interconnect board 134 housed by the terminator 100. The interconnect board 134 may be integrated with the main controller 132, such as on a common substrate. The operating system 130 also includes a feeder controller 136 and a feeder smart tag 138 housed by the feeder 104, and an applicator smart tag 140 housed by the applicator 102.

In an exemplary embodiment, the operating system 130 also includes an interface 144 and a display 146 housed by the terminator 100, but in alternative embodiments, the interface 144 and the display 146 may be housed separately from the terminator, such as on a computer system used in cooperation with the operating system 130. The operating system 130 receives commands from an operator at the interface 144. Optionally, the interface 144 may be a control panel having inputs such as push buttons, touch screen inputs, switches, knobs and the like. Alternatively, the interface 144 may be a keyboard, a mouse, a trackball, and the like. The operating system 130 provides information to the operator at the display 146. The display 146 may be a monitor, video screen, an LED display, and the like. The interface 144 and the display 146 may be integrated with one another or may be separate components.

The main controller 132 is interconnected with the interconnect board 134, the feeder controller 136, the interface 144 and the display 146. The interconnect board 134 is interconnected with the feeder smart tag 138 and the applicator smart tag 140. Optionally, the applicator smart tag 140 may be interconnected with the feeder smart tag 138, which is shown by the dashed line in FIG. 2. The applicator smart tag 140 may also be interconnected with the interface 144 and the display 146, which are also shown by dashed lines, for directly receiving information from the interface 144 and directly sending information to the display 146. Alternatively, the information may be transferred via the main controller 132 and interconnect board 134. The interconnections described above may be via wired or wireless connection. In alternative embodiments, other interconnection schemes may be available. For example, the applicator smart tag 140 may be interconnected with the interconnect board 134 via the feeder smart tag 138, or the interconnection of the feeder smart tag 138 may be made via the applicator smart tag 140. Optionally, the operating system 130 may not include an interconnect board 134, but rather the various components may communicate directly with the main controller 132.

As described above, the applicator 102 includes the applicator smart tag 140 attached thereto. The applicator smart tag 140 is a device capable of storing data relating to the applicator 102. The applicator smart tag 140 may be a memory device such as a NVRAM memory device, a FRAM memory device, an EEPROM memory device, a FLASH memory device, and the like. Optionally, the applicator smart tag 140 may include a microprocessor 148 in addition to a memory device 149. In an exemplary embodiment, the applicator smart tag 140 is a semiconductor such as the iButton® manufactured by the Dallas Semiconductor/Maxim of Maxim Integrated Products, Inc., Sunnyvale, Calif. 94086. The data stored by the applicator smart tag 140 is communicated to the interconnect board 134 and the main controller 132 via the interconnection described above. The data may be used by the main controller 132 to operate the various components and processes of the terminator 100, such as for set-up operations of the terminator 100, for the drive system of the terminator 100, for operating the feeder 104, for operating the applicator 102, and the like. Further examples of the type of data stored by the applicator smart tag 140 and the operations of the terminator 100 controlled by the data are described in further detail below.

As described above, the feeder 104 includes the feeder smart tag 138 attached thereto. The feeder smart tag 138 is a device capable of storing data relating to the feeder 104. The feeder smart tag 140 may be a memory device similar to the applicator smart tag 140. The data stored by the feeder smart tag 138 is communicated to the interconnect board 134 and the main controller 132 via the interconnection described above. In an exemplary embodiment, the data may relate to a gage position or reference point of the feeder 104. The data may also relate to a relative feed position or a relative retract position with respect to the reference point, based on a type or size of a terminal. The data may be used by the main controller 132 to operate the various components and processes of the terminator 100, such as for set-up operations of the terminator 100, for the drive system of the terminator 100, for operating the feeder 104, for operating the applicator 102, and the like. In other embodiments, the data may relate to a maintenance schedule of the feeder 104, such as an amount of time or a number of feed strokes performed since the last maintenance event, or the amount of time or number of feed strokes until the next scheduled maintenance. Further examples of the type of data stored by the feeder smart tag 138 and the operations of the feeder 104 and terminator 100 controlled by the data are described in further detail below.

In an exemplary embodiment, the feeder 104 is electrically actuated and includes a servomotor with an encoder and linear absolute position sensor for identifying a position of the feeder 104 along a feed stroke of the feeder 104. The feed stroke of the feeder 104 may be controlled by the feeder controller 136, which may be based on the data stored in the feeder smart tag 138. As described above, the feeder controller 136 is housed within the terminator 100 such as on a main control board, but in alternative embodiments may be housed within the feeder 104. The data may be communicated directly to the feeder controller 136 from the feeder smart tag 138, or the data may be communicated to the feeder controller 136 by the main controller 132. Additionally, the data from the feeder smart tag 138 may be combined with the data from the applicator smart tag 140 to determine a desired feed stroke.

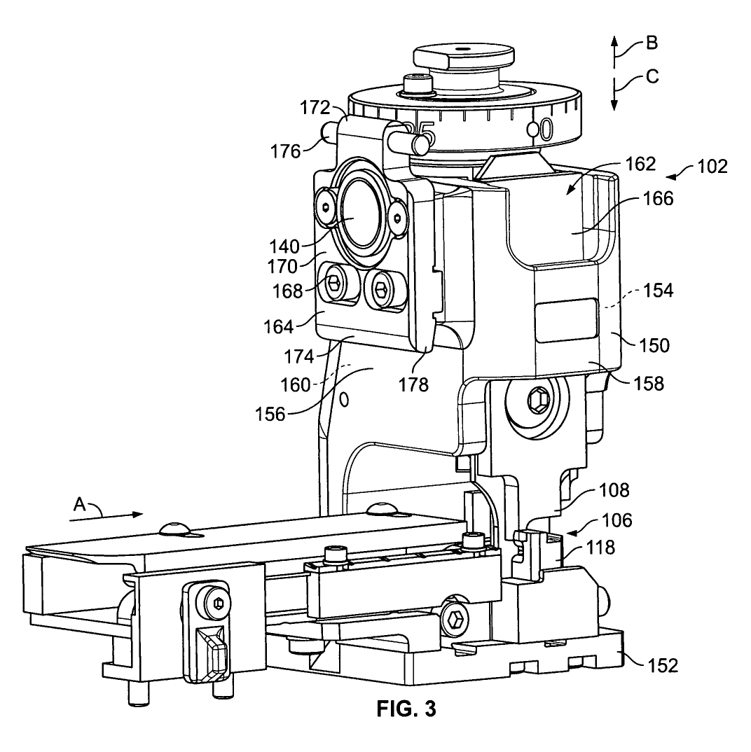

FIG. 3 illustrates a perspective view of the exemplary side-feed applicator 102. The side-feed applicator 102 is used for side-feed type terminals. The applicator 102 includes a frame 150 having a base 152. The anvil 118 is coupled to the base 152. The frame 150 includes a front 158, a rear 160, a side 154, a side 156, and a central cavity 162. A feeder support 164 extends from the side 156. The feeder 104 (shown in FIG. 1) feeds or advances the terminals 110 (shown in FIG. 1) in a feed direction from the side 156 toward the crimping zone 106, such as in the feed direction of arrow A. The terminals 110 are then presented along the front 158 at the crimping zone 106. The front and rear 158 and 160 extend generally parallel to the feed direction of the terminals 110.

A ram 166 is received within the central cavity 162 and is movable with respect to the frame 150. The crimp tooling 108 is coupled to the ram 166 and is positioned adjacent to the side 158. The ram 166 is coupled to the driving mechanism 116 (shown in FIG. 1) of the terminator 100 (shown in FIG. 1). The driving mechanism 116 moves the ram 166 vertically in a lifting or reset direction, shown by arrow B, generally away from the anvil 118 and a crimping direction, shown by arrow C, generally toward the anvil 118. The feeding of the terminals 110 and the driving of the ram 166 are coordinated. For example, as the ram 166 is moved in the lifting direction, the terminals 110 are advanced in the feed direction by the feeder 104. Optionally, the terminals 110 may also be advanced while the ram 166 is moved in the crimping direction. The terminals 110 are located in the crimping zone 106 and are stationary as the crimp-tooling nears the crimping zone 106.

The feeder support 164 is securely attached to the frame 150 by fasteners 168. A mating surface 170 faces rearwardly and interfaces with the feeder 104 (not shown) when the feeder 104 is coupled to the feeder support 164. In an exemplary embodiment, the applicator smart tag 140 is attached to the feeder support 164 and is exposed at the mating surface 170 for making electrical contact with the feeder. The feeder 104 may mechanically and electrically engage the applicator smart tag 140 when the feeder 104 is mounted to the feeder support 164. Alternatively, the applicator smart tag 140 may be housed within the feeder support 164, or another portion of the applicator 102, and make electrical contact with the feeder in another manner, such as by a contact extending to the mating surface 170. In other alternative embodiments, the applicator smart tag 140 does not make contact with the feeder 104, but rather is connected directly to the controller 122 via a dedicated connection or via a wireless connection. The feeder support 164 also extends between a top 172 and a bottom 174. The top 172 includes posts 176 extending therefrom for supporting the feeder 104. The bottom includes a lip 178 for engaging a portion of the feeder 104, as will be explained in further detail below.

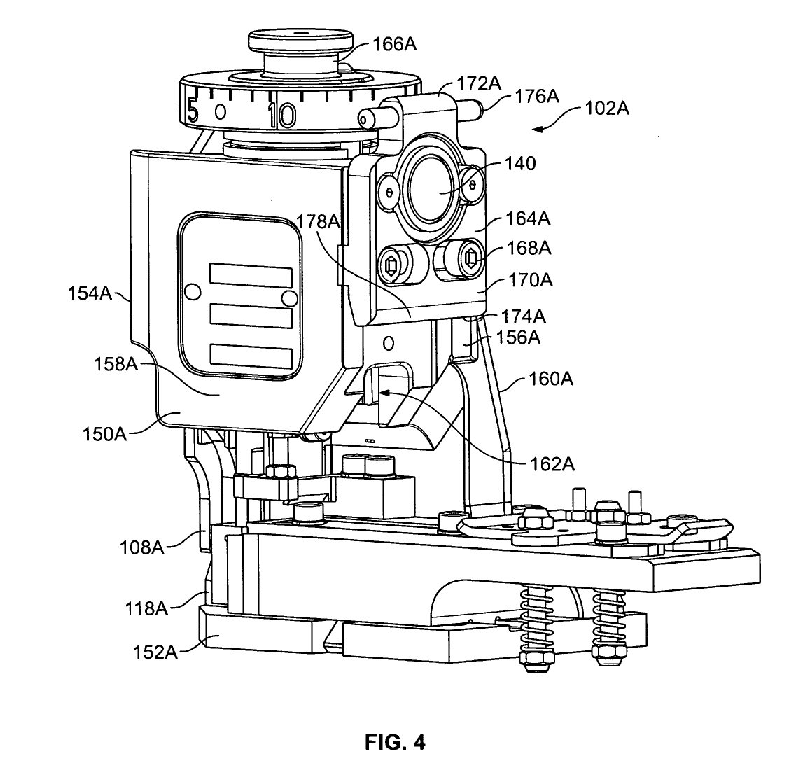

FIG. 4 illustrates a perspective view of an exemplary end-feed applicator 102A. The applicator 102A is similar to the applicator 102 shown in FIG. 3. As such, like reference numerals are used to identify like features. The end-feed applicator 102A is used for end-feed type terminals. The applicator 102A includes a frame 150A having a base 152A. The anvil 118A is coupled to the base 152A. The frame 150A includes a front 154A, a rear 156A, a side 158A, a side 160A, and a central cavity 162A. A feeder support 164A extends from the rear 156A. A ram 166A is received within the central cavity 162A and is movable with respect to the frame 150A. The crimp-tooling 108A is coupled to the ram 166A. The feeder 104 (shown in FIG. 1) may be removably coupled to the feeder support 164A to present end-feed terminals (not shown) to the crimping zone 106A of the applicator 102A. The end-feed terminals are stacked end-to-end and fed to a central portion of the rear 156A of the applicator 102A, generally equidistant from the sides 158A and 160A. The crimp-tooling 108A is also centrally located between the sides 158A and 160A.

The feeder support 164A is securely attached to the frame 150A by fasteners 168A. A mating surface 170A faces rearwardly and interfaces with the feeder 104 when the feeder 104 is coupled to the feeder support 164A. In an exemplary embodiment, the applicator smart tag 140 is attached to the feeder support 164A and is exposed at the mating surface 170A. The feeder 104 may mechanically and electrically engage the applicator smart tag 140 when the feeder 104 is mounted to the feeder support 164A. The feeder support 164A also extends between a top 172A and a bottom 174A. The top 172A includes posts 176A extending therefrom for supporting the feeder 104. The bottom includes a lip 178A for engaging a portion of the feeder 104.

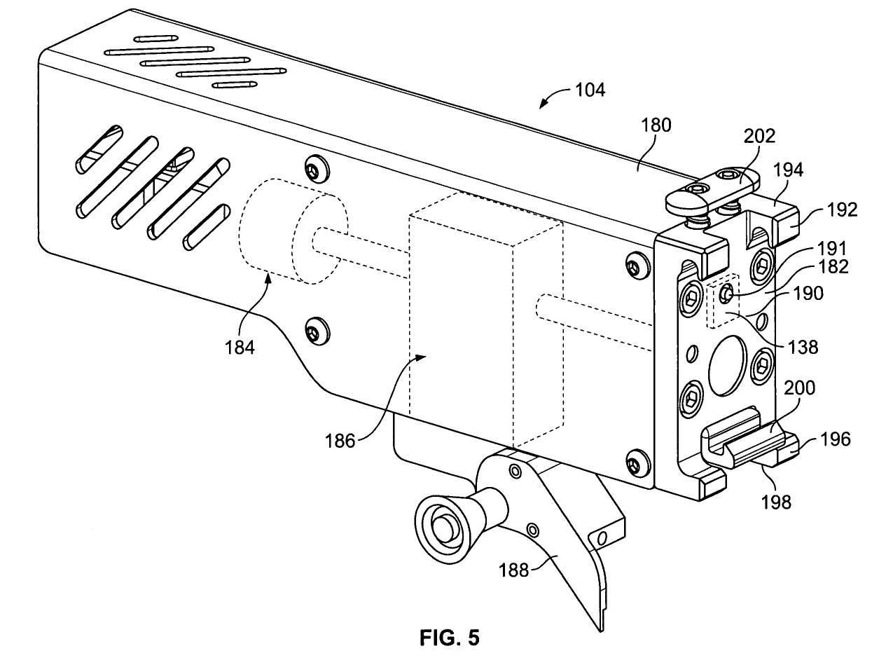

FIG. 5 illustrates a perspective view of the feeder 104 including a housing 180 extending from a support member 182. The housing 180 houses a feeder actuator 184 and a feeder carriage 186, both shown in phantom in FIG. 5. A feed finger 188 is attached to a bottom of the feeder carriage 186. The feed finger 188 engages the terminals to advance the terminals during the feed stroke of the feeder carriage 186. The feeder actuator 184 is a driving mechanism, such as a servo motor, a stepper motor, or another type of actuator such as, for example, a linear actuator, a pneumatic actuator, a piezoelectric actuator or motor, and the like. The feeder actuator 184 may be controlled by the feeder controller 136 (shown in FIG. 2). The feeder controller 136 may communicate with the control module 122 (shown in FIG. 1) to coordinate the operation of the feeder actuator 184 with the operation of the driving mechanism 116 (shown in FIG. 1).

In an exemplary embodiment, the support member 182 includes a mating surface 190 for interfacing with the mating surface 170 (shown in FIG. 3) of the feeder support 164 (shown in FIG. 3). Optionally, the feeder smart tag 138 (shown in phantom in FIG. 5) may be chip mounted and attached to a substrate mounted to, or within, the support member 182 opposite the mating surface 190. In an exemplary embodiment, a feeder probe 191 is electrically coupled to the feeder smart tag 138 and exposed at the mating interface 190. The feeder probe 191 is positioned to interface with the applicator smart tag 140 (shown in FIG. 4) for electrically coupling the feeder smart tag 138 and the applicator smart tag 140. While a single point of contact is illustrated in FIG. 5, multiple probes may be provided for multiple points of contact. When connected, signals, data and/or power may be transmitted between the probe 191 and the applicator smart tag 140. The signals, data, and or power may also be transmitted to or from the controller 122 via a hard wired connection between the feeder 104 and the controller 122.

Mounting of the feeder 104 to the applicator 102 may be accomplished via the support member 182 and the feeder support 164. The support member 182 includes hooks 192 at a top 194 of the support member 182 and feet 196 at a bottom 198 of the support member 182. The hooks 192 engage the posts 176 (shown in FIG. 3) and the feet 196 engage the lip 178 (shown in FIG. 3) of the feeder support 164. The support member 182 also includes a latch 200 having a release tab 202 for moving the latch 200. The latch 200 engages the lip 178 for securing the support member 182 to the feeder support 164. In alternative embodiments, other mounting methods and components may be provided to connect the feeder 104 to the applicator 102.

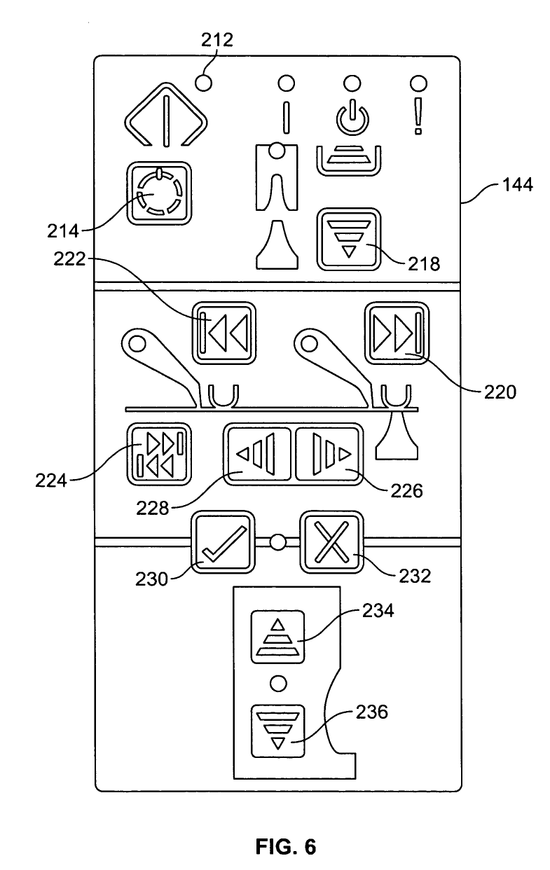

FIG. 6 illustrates an exemplary embodiment of the control interface 144 for the terminator 100 (shown in FIG. 1). The interface 144 includes a plurality of push buttons for controlling operations of the terminator 100 and a plurality of LED's associated with the push buttons. The interface 144 is interconnected with the main controller 132 of the control system 130 (illustrated in FIG. 2). When a user presses the various push buttons on the interface 144, the main controller 132 adjusts the operations or settings of the components of the terminator 100 accordingly. The interface 144 illustrated in FIG. 6 is exemplary and is not limited to the functions described herein. Other types of controls, such as touch screens, switches, buttons, knobs, and the like, may be provided for controlling the terminator 100.

The terminator 100 has a default setting based upon initial inputs from an operator. For example, an operator may input a type of terminal, a type of wire, and an amount of product to be produced. Based on the inputs from the operator, the terminator 100 may automatically set various default settings or parameters of the terminator 100, applicator 102 and feeder 104 (shown in FIG. 1) and the terminator 100 may operate in a certain way based on the inputs. In an exemplary embodiment, and as will be described in further detail below, at least some of the default settings are specific to the applicator 102, and the data stored on the applicator smart tag 140 (shown in FIG. 2) is used to establish the default settings. The interface 144 includes a default button 210 for resetting the terminator 100 settings to the default positions as established by the terminator 100 based on the data from the applicator smart tag 140. A corresponding LED 212 flashes to indicate that the default button 210 should be or has been pressed.

A main press section of the interface 144 includes a move entire cycle button 214, a jog up button 216 and a jog down button 218. When any of the buttons on the main press section are pressed, the terminator 100 operates the driving mechanism 116 (shown in FIG. 1) at a slow jog speed either through an entire cycle (e.g. when button 214 is pressed) or in an upward direction (e.g. when button 216 is pressed) or a downward direction (e.g. when button 218 is pressed) for as long as the button is pressed or until the range of motion is reached.

A feeder section of the interface 144 includes a forward button 220, a reverse button 222 and a complete feed button 224. When the buttons are pressed, the terminator 100 operates the feeder 104 (shown in FIG. 1) along a feed stroke, either through an entire cycle (e.g. when button 224 is pressed) or in an advancing direction (e.g. when button 220 is pressed) or a retracting direction (e.g. when button 222 is pressed). The feeder section of the interface 144 also includes a fine adjust forward button 226 and a fine adjust back button 228. The fine adjust buttons 226, 228 may be used to control the range of motion of the feed stroke, such as a forward-most or advanced position and a rearward-most or retracted position. The fine adjust adjustments are useful for setting up the terminator 100, such as when the default feed stroke may need minor adjustment to position the terminal 112 with respect to the applicator 102 or to position the feed finger 188 (shown in FIG. 5) to gather the next terminal 110. The fine adjustments may be stored by the applicator smart tag 140 and/or the feeder smart tag 138 for future reference, or to set as the default setting the next time the terminator 100 is set up. When a fine adjustment is made, the interface 144 may require the operator to either accept or reject the adjustment. The interface 144 includes an accept button 230 and a reject button 232 for this purpose.

A vertical height section of the interface 144 includes a raise button 234 and a lower button 236. When the raise or lower buttons 234, 236 are pressed, the terminator 100 operates a device to raise or lower, respectively, the crimping zone 106 (shown in FIG. 1) with respect to the wire 112. For example, the applicator 102 may be raised or lowered. The raising and lowering may be used to correctly align the wire 112 within the crimping zone 106. When the raise or lower buttons 234, 236 are pressed, the interface 144 may require the operator to either accept or reject the adjustment. The accept and reject buttons 230, 232 are provided for this purpose. Additionally, data relating to the raised or lowered position may be stored in the applicator smart tag 140 for future use by the terminator 100.

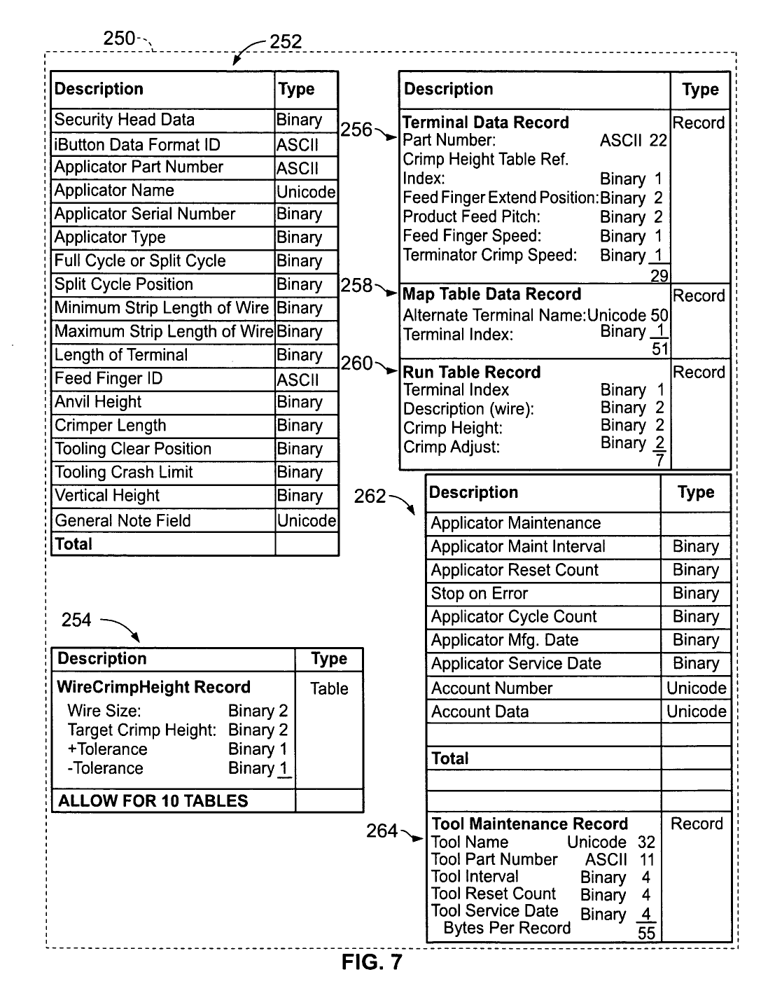

FIG. 7 illustrates an exemplary database system 250 for the terminator 100 (shown in FIG. 1). The database system 250 may be stored within the control module 122 (shown in FIG. 1) associated with the terminator 100 or within a computer system used with the terminator 100 and communicating with the control module 122. The database system 250 includes a plurality of sections, each having multiple fields. The sections and fields illustrated in FIG. 7 are exemplary and other data fields may be included in alternative embodiments. In an exemplary embodiment, the data fields are the same as, or similar to, corresponding data fields included within the applicator smart tag 140 and/or the feeder smart tag 138. Additionally, data gathered by the smart tags 140, 138 is used to populate the data fields within the database system 250, such as through the interconnections described with reference to FIG. 2.

The database system 250 includes a general field section 252, a wire crimp height record section 254, a terminal data record section 256, a map table data record section 258, a run table record section 260, an applicator maintenance section 262 and a tool maintenance record section 264. Each of the sections may be presented to an operator through an interface, such as the display 146 (shown in FIG. 2). The sections may be presented in a single window or in multiple windows. The sections may be presented to the operator in drop down menus. The data contained within the fields may be preprogrammed within the database system 250, may be selectively modified by the operator, or may be automatically entered or updated by the smart tag 140. The fields may be populated with numbers, letters, mathematical functions, operators, and the like.

The general field section 252 includes a plurality of fields that are specific to the applicator 102. As such, different applicators may have different data contained within the fields of the general fields section 252. For example, the security head data field includes security data that restricts operation of the terminator 100 under certain conditions, such as when an incorrect or un-useable applicator 102 is being used with the terminator 100. The smart tag data format ID field includes information relating to the version number of the smart tag. New versions of smart tags having new or different data fields may be provided and recognized by the database system 250. The applicator part number, name, and serial number fields include data unique to the applicator 102. The name is a name that may be entered by the operator to identify the applicator. The applicator type field relates to the type of applicator, such as side-feed or end-feed. The type field may be more specific in alternative embodiments. The full cycle or split cycle field and the split cycle position field are specific fields that relate to the type of terminal being used, such as an open or closed type of terminal. For example, when a closed type terminal is used, the applicator 102 may be run in split cycle to hold the terminal in place prior to the crimp. The minimum and maximum strip length of wire fields include information relating to an amount of wire exposed when the insulation is removed. These data fields are preprogrammed based on the terminals being run by the applicator. The length of terminal field is a preprogrammed, default value based on the terminal. The feed finger ID field is used to identify the feed finger required for the particular applicator and terminal being used for the run. The data to populate this field is preprogrammed in the applicator smart tag and is based on the terminals being run by the applicator. The anvil height, crimper length, tooling clear position, and tooling crash limit fields include data relating to the crimping process, such as the relative positions of the anvil and crimp tooling. The data to populate these fields are preprogrammed in the applicator smart tag. The vertical height data field is initially preprogrammed but may be adjusted by the operator over time. Adjustments made by the operator may be saved within the smart tag 140 for future use. The general field section 252 also includes a general note section that may be populated with notes by the operator.

The wire crimp height record section 254 includes a wire size field, a target crimp height field, a +tolerance field and a −tolerance field. The data within the fields of the section 254 may be preprogrammed within the database and is automatically populated by data contained within the smart tag 140. The correct wire size and target crimp height data is selected based on the particular run of the terminator 100. For example, the operator may select the terminal from a drop down menu from the list of possible terminals, the wire size from a drop down menu from a list of possible wire sizes, and the target crimp height and tolerances may be automatically populated based on default settings relating to the selected terminal. The operator may also select a different target crimp height and tolerance field stored in the run table record, which is described in further detail below. The different values may be based on adjustments stored within the database system 250 and/or the smart tag 140, and are used for setting up a later run.

The terminal data record section 256 includes a part number field identifying the terminals. The data in this field is preprogrammed with a list of possible terminals that the applicator can run. The ability exists for the operator to add terminals and data to the database as new terminals are designed to be run in the applicator. A crimp height table ref. index field is provided to identify the correct crimp height table that relates to the terminal. A feed finger extend position field and a product feed pitch field are provided to identify a feed finger forward position and a feed finger reverse position, respectively, based on the particular type of terminal. These forward and rearward positions for the feed finger are automatically selected based on the terminal that is selected. The data from these fields is stored by the applicator smart tag 140. The data in the feed finger extend position field and the product feed pitch field are relative positions based on the information within the feeder smart tag 138. A feed finger speed field and a terminator crimp speed field are provided and include information relating to a feed speed and a crimp speed, respectively. As indicated above, when using the feeder 104 having an electrical actuator that is separate from the crimping motion, the feeder 104 may feed the terminals along a different motion profile (e.g. speed, rate, direction) than the drive system of the terminator drives the applicator 102. The data within the feed finger speed field and the terminator crimp speed field may be selected manually or automatically using default settings.

The map table data record section 258 includes an alternative terminal name field which allows the operator to input data relating to an alternative terminal name, such as a customers name used by the operator or a customer to identify the terminal.

The run table record section 260 includes a terminal index field which includes data that identifies the terminal for the particular run. A wire description field is provided which includes data that identifies the wire size for the particular run. A crimp height field is provided which includes data that identifies the target crimp height for the particular run. The crimp adjust field also identifies a crimp adjust distance that the terminator 100 may use to achieve the target crimp height. The run table record is automatically populated for each particular run and is stored by the smart tag 140. In one embodiment, the applicator smart tag 140 stores data relating to incremental changes during the set-up operation by the operator. For example, when the crimp height is adjusted, the adjustment is stored. For a particular run of a particular terminal and wire, the crimp height is selected and the adjustments made by the operator for the particular applicator are stored. For successive runs using the same terminal and wire, the value corresponding to the combination of the terminal, wire, and crimp height may be easily selected, causing the set-up for the successive run to be more accurate than a set-up using the default crimp height adjust.

The applicator maintenance section 262 includes an applicator maintenance interval field and an applicator reset count field. The interval field includes data relating to an interval between maintenance, and may be based upon time, use, or some other characteristic. The interval may be populated with a default interval or may be changed by operator input. The reset count field includes data relating to the interval, such as the amount of the interval that has been used. A stop on error field is also included. The operator may desire that the terminator 100 shut down when a maintenance is scheduled, such as at the end of the maintenance interval. The stop on error field may include data of “yes” or “no”. An applicator cycle count field includes data relating to a total number of cycles for the applicator. The cycles may be counted as a total number of cycles, or as a number of cycles from a predetermined start time, such as the beginning of a run, the last reset, the last maintenance, and the like. An applicator mfg. date field may be provided including data relating to the date of manufacture of the applicator. An applicator service date field may be provided including data relating to the date of last service. An account number field and an account data field may be provided to identify the account and information relating to the account. The account may be a particular company division, a particular customer and the like.

The tool maintenance record section 264 includes information relating to tool maintenance. A tool is a wearable component of the applicator 102 and may include components such as a wire crimper, an insulation crimper, an anvil, a front shear, a front shear holder, a rear shear, a rear shear holder cut, a rear shear plate, and the like. The tool may also relate to particular maintenance tasks, such as cleaning the applicator, lubricating the applicator and the like. A tool name field and a tool part number field include data relating to the name of the tool and the part number of the tool, respectively, if applicable. A tool interval field includes data relating to the interval period until the next maintenance is desired. The interval may be based on a time, such as in minutes, hours or days, or the interval may be based on a number of cycles or strokes. The interval may be populated with a default interval or may be changed by operator input. A tool reset count field includes data relating to the interval, such as the amount of the interval that has been used. A tool service date field may be provided including data relating to the date of last service.

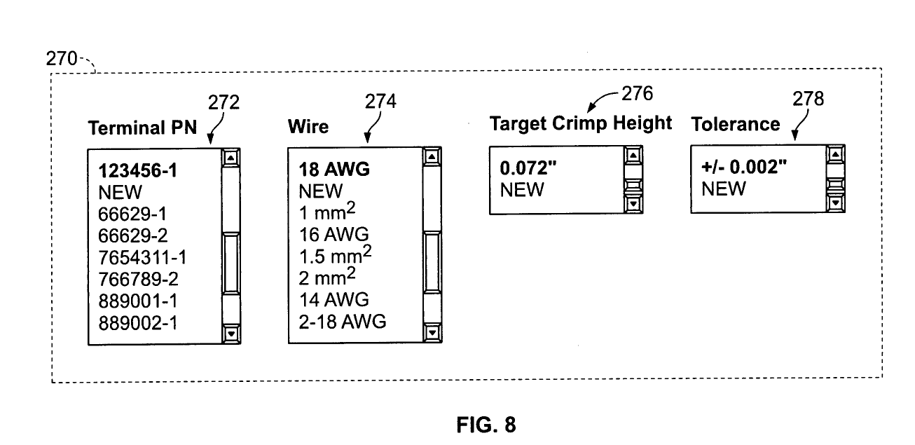

FIG. 8 illustrates an exemplary interface 270 for selecting from the database system 250 illustrated in FIG. 7. The interface 270 may include an interface component and display component, such as the interface 144 and display 146 illustrated in FIG. 2. As such, the operator may view multiple menus and select appropriate values to populate the database system 250. The interface 270 communicates with the main controller 132 (shown in FIG. 2) associated with the terminator 100 (shown in FIG. 1) or with a computer system used with the terminator 100.

In operation, the operator selects certain parameters, which are communicated to the terminator 100 to operate the terminator 100. For example, because the terminator 100 operates differently depending on a terminal type and a wire size, these parameters should be selected from the interface 270 during set-up of the terminator 100. In an exemplary embodiment, the operator selects the parameters from a list of parameters in drop down menus. In the illustrated embodiment, the interface 270 includes a terminal part number menu 272, a wire selection menu 274, a target crimp height menu 276 and a tolerance menu 278. The operator selects a terminal type from the terminal part number menu 272. The operator selects a wire type from the wire selection menu 274. The operator selects a target crimp height from the target crimp height menu 276. The operator selects a tolerance from the tolerance menu 278. The menus and selections within the menus are exemplary and other menus and selections may be included in alternative embodiments of the database system 250.

With reference to the above description and figures, exemplary devices and methods for operating a terminating machine 100 are provided. The terminating machine 100 includes various components, such as a drive system 116, an applicator 102, a feeder 104, and the like. Each of these components may be operated by a control system 130 or computer to terminate a terminal to a wire. The terminating machine 100 includes an applicator smart tag 140 and/or a feeder smart tag 138 communicating with the control system 130 to ease the operation of the terminating machine 100. The smart tags 138, 140 are carried by the applicator 102 and/or feeder 104 for readily accessing the information contained within the smart tags 138, 140. The smart tags 138, 140 may also ease the set-up of the terminating machine 100. The smart tags 138, 140 include data relating to the specific applicator 102 and/or feeder 104, such that when that particular applicator 102 and/or feeder 104 is used with the terminating machine 100, the operation and/or set-up is specific to the applicator 102 and/or feeder 104. The terminating machine 100 is automatically configured based on the data within the smart tags 138, 140. The data contained within the smart tags 138, 140 may be updated over time to reflect information, such as set-up changes performed by an operator or maintenance records or needs. The information can be viewed by the operator and used by the operator to more efficiently operate the termination machine 100.

The smart tags 140 have the ability to store the data relating to the machine adjustments for each specific applicator 102 required to properly operate the applicator 102. Additionally, the data may be entered on the smart tag 140 at the time of assembly of the applicator 102 in the factory, thereby further reducing the manual steps and setup time required by an operator.

In one embodiment, a controller 122 interfaces with the smart tag 140 to read the data stored in the smart tag 140. The data is then automatically uploaded from the applicator to the terminating machine 100 as the applicator 102 is installed on the termination machine 100. The controller 122 interfaces with the controls of the termination machine 100 to automatically make setup adjustments for the specific applicator 102.

In one application, the smart tag 140 stores the feed position settings in the applicator 102. When the applicator 102 is mounted in the termination machine 100, the feed position settings are recalled to provide the proper setup for the termination machine 100. A memory device 149 and/or a microprocessor 148 may also form part of the feeder 104 to maintain calibration data for proper positioning.

In addition to the data storage and data transmitting capabilities of the smart tags 140, the termination machine 100 also includes the ability to download changes to the data for future use. Thus, new information or added capabilities may be downloaded to the smart tag 140 for future use.

While the invention has been described in terms of various specific embodiments, those skilled in the art will recognize that the invention can be practiced with modification within the spirit and scope of the claims.

What is claimed is:

1. A termination system used to apply a terminal to a wire, the system comprising:
an applicator including a movable ram configured to be driven by a termination machine, and tooling coupled to the movable ram and configured to apply the terminal to the wire; and
a smart tag having data related to the applicator and configured to communicate with the termination machine to control an operation of the termination machine.

2. A system in accordance with claim 1, wherein the smart tag stores data in a memory.

3. A system in accordance with claim 1, wherein the smart tag is configured to send data to and receive data from a microprocessor of the termination machine.

4. A system in accordance with claim 1, wherein the smart tag is permanently mounted to the applicator.

5. A system in accordance with claim 1, wherein the smart tag communicates with the termination machine via one of a wired and a wireless connection.

6. A system in accordance with claim 1, wherein the smart tag includes a microprocessor and a memory for storing data.

7. A system in accordance with claim 1, wherein the smart tag stores at least one of:
data relating to a feeding operation of the terminating machine;
data relating to a terminating operation of the terminating machine;
data relating to set-up parameters for the terminating machine;
data relating to changes in the set-up parameters of the terminating machine;
data relating to a maintenance schedule of the applicator; and
data relating to identification of the applicator.

8. A system in accordance with claim 1, further comprising a termination machine having an operating system and configured to receive more than one type of applicator, the termination machine receiving the applicator such that the smart tag communicates with the operating system.

9. A termination system for applying a terminal to a wire, the termination system comprising:
an applicator having a movable ram, tooling coupled to the movable ram and configured to apply the terminal to the wire, and a smart tag having data relating to the applicator; and
a termination machine having a driving mechanism coupled to the movable ram for driving the movable ram along a termination stroke and an operating system configured to operate the driving mechanism, wherein the operating system communicates with the smart tag to control an operation of the termination machine.

10. A termination system in accordance with claim 9, wherein the smart tag stores data in a memory.

11. A termination system in accordance with claim 9, wherein the smart tag sends data to, and receives data from, a microprocessor of the termination machine.

12. A termination system in accordance with claim 9, wherein the smart tag stores at least one of:
data relating to a feeding operation of the terminating machine;
data relating to a terminating operation of the terminating machine;
data relating to set-up parameters for the terminating machine;
data relating to changes in the set-up parameters of the terminating machine;
data relating to a maintenance schedule of the applicator; and
data relating to identification of the applicator.

13. A termination system in accordance with claim 9, wherein the operating system includes a microprocessor for controlling the operation of the driving mechanism, wherein the microprocessor communicates with the smart tag.

14. A termination system in accordance with claim 9, further comprising a feeder configured to feed the terminals to the tooling, the feeder coupled to the actuator and controlled by the operating system, the feeder being operated by the operating system based on the data stored by the smart tag.

15. A termination system in accordance with claim 9, further comprising an electrically actuated feeder configured to feed the terminals to the tooling, the feeder includes a feeder smart tag having data relating to the operation of the feeder, wherein the feeder smart tag communicates the data to the operating system.

16. A method of operating a termination machine including an applicator having a smart tag, the method comprising:
storing terminal crimping applicator specific data in the smart tag of the applicator;
mounting the applicator onto the termination machine;
uploading the data to the termination machine; and
operating the termination machine based on the uploaded data.

17. A method in accordance with claim 16, wherein the data includes setup data for the termination machine.

18. A method in accordance with claim 16, wherein the data includes setup data for the termination machine, and wherein the setup data is updatable and the updated setup data is stored on the smart tag.

19. A method in accordance with claim 16, wherein the data is uploaded to the termination machine via one of a wired or wireless connection between the applicator and a microprocessor of the termination machine.

20. A method comprising assembling a termination machine configured to operate in accordance with claim 16.
